(19) United States
(12) Patent Application Publication
(10) Pub. No.: US 2020/0223023 A1
(43) Pub. Date: Jul. 16, 2020

(54) FOLDING DEVICE FOR MILLING MACHINE

(71) Applicant: TAIWAN AXIS DYNAMIC CO, LTD., Taichung City (TW)

(72) Inventor: YEN-KUANG CHANG, TAICHUNG CITY (TW)

(21) Appl. No.: 16/249,188

(22) Filed: Jan. 16, 2019

(51) Int. Cl. B23Q 1/64; B23C 1/20; B23Q 1/00; B23Q 1/03

(52) U.S. Cl. CPC B23Q 1/64; B23Q 1/03; B23Q 1/0054; B23C 1/20

(57) ABSTRACT

A folding device for a milling machine includes a base having a workbench formed on top thereof, and two support parts are respectively located on two sides of the workbench so as to be connected to two support boards respectively. A pivot and a fixing bolt extend through the contact face and are fixed to the support part. A driving unit includes a transverse rail and a transverse shaft respectively connected between the two support boards. A slide is slidably connected with the transverse rail and the transverse shaft. A milling machine is connected to the slide which is movable between the two support boards. When the fixing bolts are removed, the milling machine is foldable toward the workbench about the two respective pivots to save transportation space and storage space required.

### BACKGROUND OF THE INVENTION

### 1. Fields of the Invention

The present invention relates to a folding device for a milling machine, and more particularly, to a folding device that allows the milling machine to be folded toward the workbench to save room.

### 2. Descriptions of Related Art

The conventional folding device known to applicant includes an X-axis unit, a Y-axis unit and a Z-axis unit. The milling machine is movable between the X-axis unit, the Y-axis unit and the Z-axis unit to meet different machining requirements. Each of the X-axis unit, the Y-axis unit and the Z-axis has a certain height, and a respective guiding mechanism and securing mechanism. The guiding mechanism guides the milling machine to a desired position, and the securing mechanism securely positions the milling machine at the desired position. It is noted that the milling machine is used to machine objects precisely so that the X-axis unit, the Y-axis unit and the Z-axis unit are not expected to be dis-assembled and assembled frequently. Besides, the X-axis unit, the Y-axis unit and the Z-axis unit occupy a significant space that is difficult to be packed and transported.

The present invention is intended to provide a folding device that allows the milling machine to be folded toward the workbench to save storage and transportation room.

### SUMMARY OF THE INVENTION

The present invention relates to a folding device for a milling machine, and comprises a base having a workbench formed on top thereof. Two support parts are respectively located on two sides of the workbench and each support part is connected with a support board. A pivot and a fixing bolt extend through the support board and are fixed to the support part. A driving unit includes a transverse rail, a transverse shaft and a slide, wherein the transverse rail is connected between the two support boards. Two ends of the transverse shaft extend through the two support boards, and the transverse shaft is parallel to the transverse. The slide is slidably connected with the transverse rail and the transverse shaft. A milling machine is connected to the slide which is movable between the two support boards. When the fixing bolts are removed from the support parts and the support boards, the milling machine is foldable toward the workbench about the two respective pivots.

Preferably, the milling machine includes a pillar and a lift frame, wherein the lift frame includes a top board and a bottom board so as to be fixed a top face and a bottom face of the slide by screws. The pillar includes a guide face which faces the lift frame. The pillar is movable relative to the lift frame and movable perpendicularly relative to the transverse rail and the transverse shaft.

Preferably, the milling machine is dis-connected from the slide and put on the workbench when the screws are removed from the top board, the bottom boards, the top face and the bottom face of the slide.

Preferably, each of the two support boards includes a bore through which the transverse shaft extends.

Preferably, the each of the two support boards includes two through holes. The installation face of each support part includes two threaded holes which are located corresponding to the two through holes. The pivot and the fixing bolt respectively extend through the two through holes and are fixed to the two threaded holes.

Preferably, each of the two support boards is connected to a cover mounted to outside thereof. The cover is located opposite to the contact face of the support board so as to cover up the end of the transverse shaft that extends through the support board.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the folding device and the milling machine of the present invention;

FIG. 2 is a perspective view to show that two covers are to be connected to the support boards of the folding device of the present invention;

FIG. 3 is an cross sectional view, taken along line III-III of FIG. 1;

FIG. 4 shows that milling machine is removed from the slide by removing the screws of the top board and the bottom boards of the lift frame;

FIG. 5 shows that the folding device is folded and the milling machine is put on the workbench;

FIG. 6 shows the height of the folding device and the milling machine by dotted lines;

FIG. 7 shows the height of the folded status of folding device and the milling machine by dotted lines.

### DETAILED DESCRIPTION OF THE PREFERRED EMBODIMENT

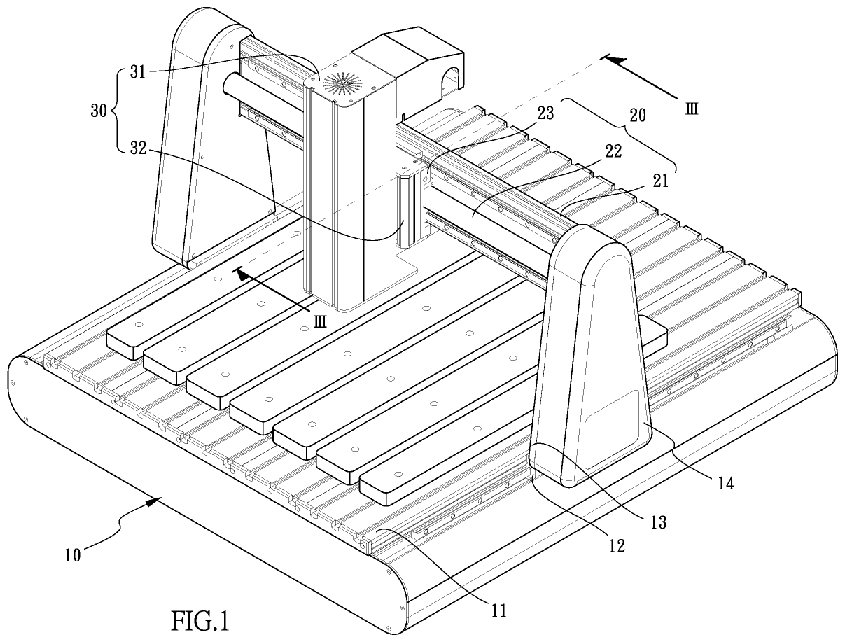

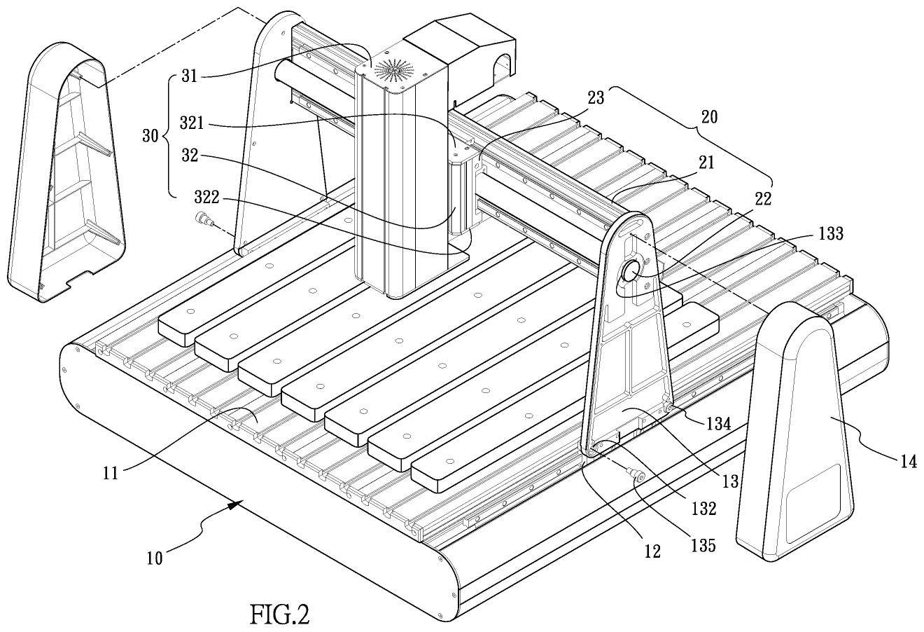

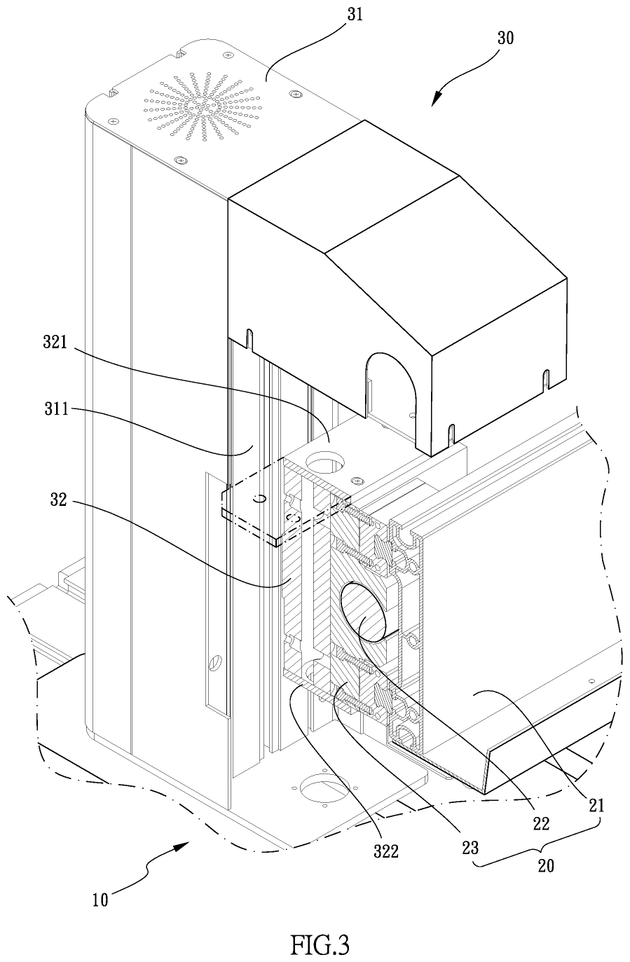

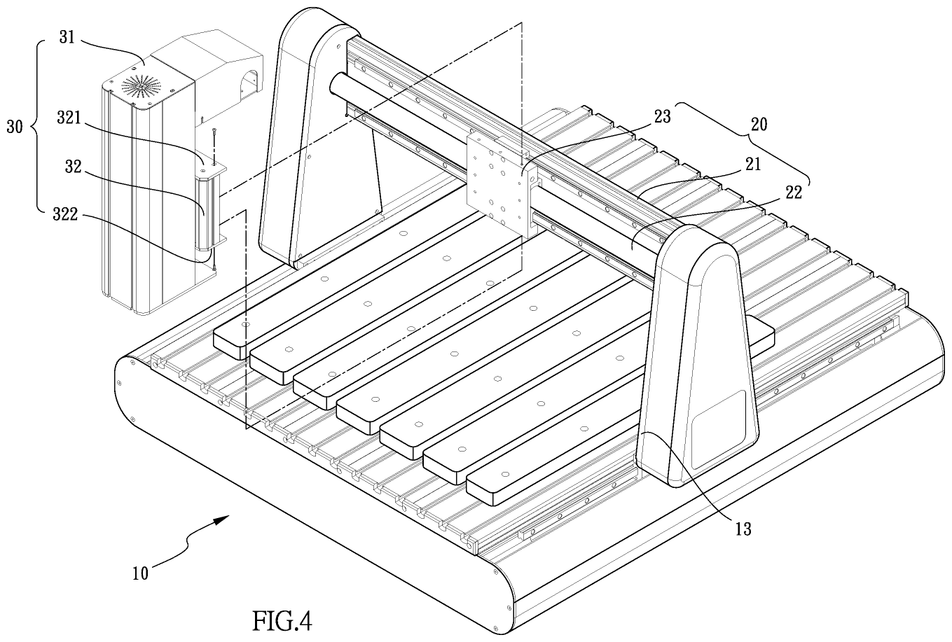

Referring to FIGS. 1 to 4, the folding device of the present invention comprises a base 10 having a workbench 11 formed on the top thereof, and two support parts 12 are respectively located on two sides of the workbench 11. Each support part 12 includes an installation face 121 formed on outside thereof. Each support part 12 is connected with a support board 13. Each support board 13 includes a contact face 131 which contacts the installation face 121 of the support part 12 corresponding thereto. A pivot 134 and a fixing bolt 135 extend through the contact face 131 and are fixed to the installation face 121. Specifically, each of the two support boards 13 includes two through holes 132. The installation face 121 of each support part 12 includes two threaded holes 122 which are located corresponding to the two through holes 132. The pivot 134 and the fixing bolt 135 respectively extend through the two through holes 132 and are fixed to the two threaded holes 122 to fix the support board 13 to the support part 12 corresponding thereto.

A driving unit 20 includes a transverse rail 21, a transverse shaft 22 and a slide 23. The transverse rail 21 is connected between the two support boards 13, and the two ends of the transverse shaft 22 extend through the two support boards 13. Specifically, each of the two support boards 13 includes a bore 133 through which the transverse shaft 22 extends. The transverse shaft 22 is parallel to the transverse rail 21. The slide 23 is slidably connected with the transverse rail 21 and the transverse shaft 22. Each of the two support boards 13 is connected to a cover 14 mounted to outside thereof. The cover 14 is located opposite to the contact face 131 of the support board 13 so as to cover up and to protect the end of the transverse shaft 22 that extends through the support board 13.

A milling machine 30 is connected to the slide 23 which is movable between the two support boards 13. Specifically, the milling machine 30 includes a pillar 31 and a lift frame 32. The lift frame 32 includes a top board 321 and a bottom board 322, and the top board 321 and the bottom boards 322 are fixed to the top face and the bottom face of the slide 23 by screws. The pillar 31 includes a guide face 311 which faces the lift frame 32. The pillar 31 is movable relative to the lift frame 32 and movable perpendicularly relative to the transverse rail 21 and the transverse shaft 22.

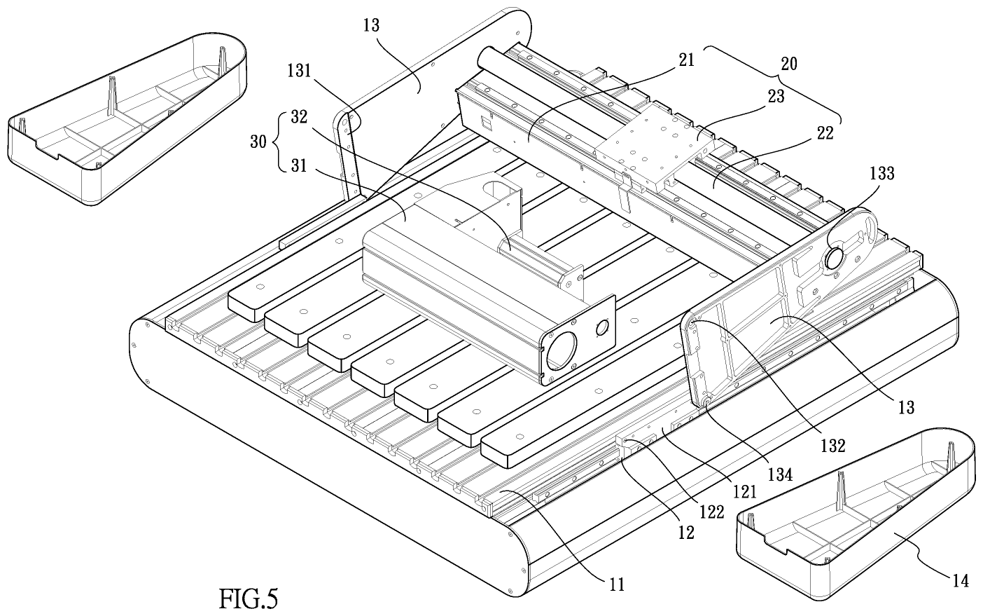

As shown in FIG. 5, the milling machine 30 is dis-connected from the slide 23 and put on the workbench 11 when the screws are removed from the top board 321, the bottom boards 322, the top face and the bottom face of the slide 23. When the fixing bolts 135 are removed from the support parts 12 and the support boards 13, the milling machine 30 is foldable toward the workbench about the two respective pivots 134.

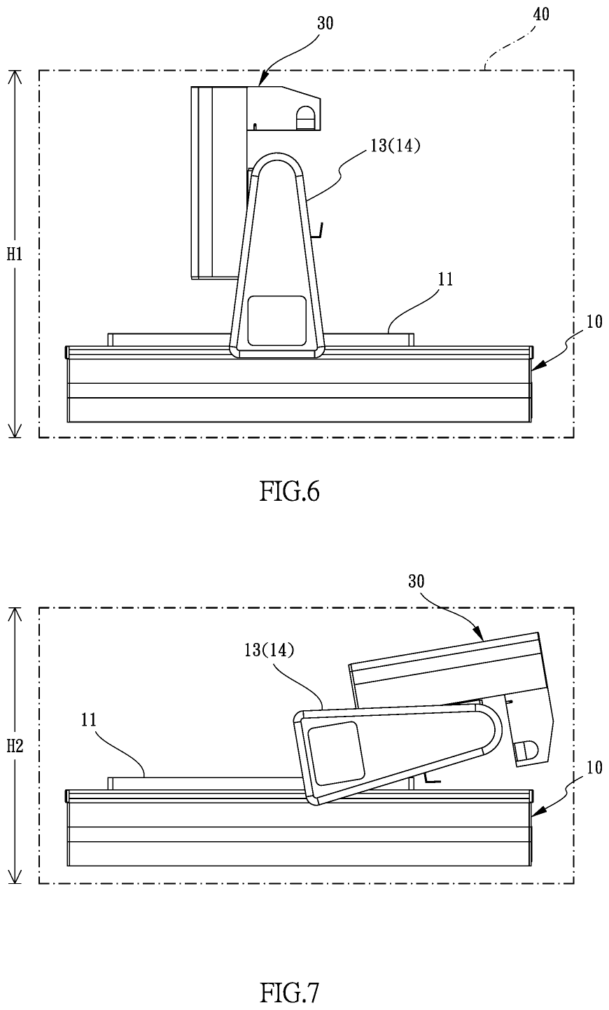

As shown in FIGS. 6 and 7, when the milling machine is connected to the driving unit 20 as shown in FIG. 6, as shown by dotted lines, the height “H1” is longer than the height “H2 when the support boards 13 together with the covers 14, and the milling machine 30 are folded toward the workbench 11 of the base 10.

While we have shown and described the embodiment in accordance with the present invention, it should be clear to those skilled in the art that further embodiments may be made without departing from the scope of the present invention.

What is claimed is:

1. A folding device for a milling machine, comprising:
a base having a workbench formed on a top thereof, two support parts respectively located on two sides of the workbench, each support part having an installation face formed on an outside thereof, each support part connected with a support board which includes a contact face which contacts the installation face of the support part corresponding thereto, a pivot and a fixing bolt extending through the contact face and being fixed to the installation face, and
a driving unit including a transverse rail, a transverse shaft and a slide, the transverse rail connected between the two support boards, two ends of the transverse shaft extending through the two support boards, the transverse shaft being parallel to the transverse rail, the slide slidably connected with the transverse rail and the transverse shaft, a milling machine connected to the slide which is movable between the two support boards, when the fixing bolts are removed from the support parts and the support boards, the milling machine is foldable toward the workbench about the two respective pivots.

2. The folding device for a milling machine as claimed in claim 1, wherein the milling machine includes a pillar and a lift frame, the lift frame includes a top board and a bottom board, the top board and the bottom boards are fixed to a top face and a bottom face of the slide by screws, the pillar includes a guide face which faces the lift frame, the pillar is movable relative to the lift frame and movable perpendicularly relative to the transverse rail and the transverse shaft.

3. The folding device for a milling machine as claimed in claim 2, wherein the milling machine is dis-connected from the slide and put on the workbench when the screws are removed from the top board, the bottom boards, the top face and the bottom face of the slide.

4. The folding device for a milling machine as claimed in claim 1, wherein each of the two support boards includes a bore through which the transverse shaft extends.

5. The folding device for a milling machine as claimed in claim 1, wherein each of the two support boards includes two through holes, the installation face of each support part includes two threaded holes which are located corresponding to the two through holes, the pivot and the fixing bolt respectively extending through the two through holes and are fixed to the two threaded holes.

6. The folding device for a milling machine as claimed in claim 1, wherein each of the two support boards is connected to a cover mounted to outside thereof, the cover is located opposite to the contact face of the support board so as to cover up the end of the transverse shaft that extends through the support board.
